(19) United States
(12) Patent Application Publication
(10) Pub. No.: US 2026/0095898 A1
(43) Pub. Date: Apr. 2, 2026

(54) Automated Layer 1 Configuration in a Network Device

(71) Applicant: Arista Networks, Inc., Santa Clara, CA (US)

(72) Inventors: Zeyad Essam R. Aburajab Tamimi, Vancouver (CA); Jackson Ryan EMBREY, Surrey (CA); Ravil BAIZHIYENOV, Burnaby (CA); Paul Martin FALLON, Mountain View, CA (US); John PEACH, Maidenhead (GB)

(21) Appl. No.: 18/902,602

(22) Filed: Sep. 30, 2024

(51) Int. Cl. H04W 72/04; H04L 69/323

(52) U.S. Cl. CPC H04W 72/04; H04L 69/323

(57) ABSTRACT

Configuration of Layer 1 resources (hardware components) in a network device includes building a hierarchical representation of the resources (resource hierarchy). Connections between resources in the hierarchy indicate interdependencies between their configurations. A pass is made through the resource hierarchy to set any configuration parameters specified by the user. Another pass is made through the resource hierarchy to constrain the configuration space of any configuration parameters affected by the user-specified parameters. Another pass is made through the resource hierarchy to configure resources that were not configured by the user, taking into account the constrained configuration space of any configuration parameters affected by the user-specified parameters.

### BACKGROUND

The Open Systems Interconnection (OSI) model is a reference model that describes how computers communicate over a network. The lowest layer of a communications system according to the OSI model is known as Layer 1 (L1), the physical layer. Some network devices have configurable hardware components that operate at L1 (L1 resources).

L1 configurations, however, are becoming increasingly complicated due to the interactions between resources. For example, on some network devices, some interface speed changes must be accompanied by a data rate (phase lock loop (PLL)) setting change to enable the PHY core to drive the SerDes at a desired rate, otherwise the interface speed change will result in a degraded or inoperable link. The process of configuring a network device thus requires a deep understanding of the physical topology of the network device and the different limitations of the L1 components in the system.

Historically, network devices were installed with fixed configurations and allowed few, if any, changes at runtime. In these scenarios, an engineering team with the expertise to understand all the interactions between resources would set the L1 configuration before the network device was used in operation.

Some network devices allow the network device operator to manually configure a limited number of L1 resources. However, because network device operators often lack the necessary understanding of the interactions between L1 resources in the network device, it is common for network device operators to configure network devices with incompatible settings that result in unexpected behavior.

Further, some modern network devices have operating systems that provide automatic configuration of a small number of L1 resources. For example, some network devices automatically adjust the interface speed and forward error correction (FEC) encoding to match the requirements of a new transceiver when the new transceiver is installed in the network device. The automatic adjustments are made in isolation, without considering the effect on the system or other resources, which can result in poor or confusing end behavior that requires manual intervention to resolve.

Therefore, there is a need for improved mechanisms for configuring the L1 resources of a network device.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 is a high-level representation of a network device in accordance with the present disclosure.

FIG. 2A is a diagrammatic representation of one embodiment of a resource hierarchy for network device configuration resolution in accordance with some embodiments.

FIG. 2B illustrates a portion of the resource hierarchy of FIG. 2A.

FIG. 2C illustrates another portion of the resource hierarchy of FIG. 2A.

FIG. 3 is an illustrative representation of processing blocks in a configuration resolver in accordance with some embodiments of the present disclosure.

FIG. 4 is a high-level illustrative flow of operations that represents the automatic resolution of configuration parameters in accordance with some embodiments.

FIG. 5 is a high-level illustrative flow of operations that represents an aspect of the automatic resolution of configuration parameters in accordance with some embodiments.

FIG. 6 is a high-level illustrative flow of operations that represents an aspect of the automatic resolution of configuration parameters in accordance with some embodiments.

FIG. 7A illustrates a portion of the resource hierarchy of FIG. 2A with an example of a manually configured configuration parameter.

FIG. 7B illustrates another portion of the resource hierarchy of FIG. 2A with another example of a manually configured configuration parameter.

FIG. 7C illustrates example configuration spaces for the Port 1 node and Port 2 node of FIG. 2A.

FIG. 7D illustrates an example configuration space for the Port 3 node and Port 4 node of FIG. 2A.

FIG. 7E illustrates an example configuration space for the Port Group 1 node of FIG. 2A.

FIG. 7F illustrates an example of a constrained configuration space for the Port Group 1 node of FIG. 2A.

FIG. 7G illustrates example configuration spaces for the Port Group 2 node and the Port Group 3 node of FIG. 2A.

FIG. 7H illustrates an example constrained configuration space for one embodiment of a network device represented by the resource hierarchy of FIG. 2A.

### DETAILED DESCRIPTION

In general, embodiments in accordance with the present disclosure relate to mechanisms for configuring network devices. More specifically, embodiments include functionality to automatically determine a hardware-compatible L1 configuration based on the hardware resource limitations of the network device, with limited or no manual user configuration.

### Overview

A network device may have any number of L1 configuration parameters (or simply parameters) that can be configured at the control plane. The L1 configuration for a network device may thus be a collection of configured L1 parameters that is used internally by the network device to configure the hardware resources of the network device. Some L1 configuration parameters, however, may be interrelated such that configuring them with incompatible configurations results in undesired behavior when applied to the hardware resources.

Embodiments in accordance with the present disclosure automatically determine a hardware-compatible L1 configuration based on the hardware resource limitations of the network device and operator intent. Operator intent can be derived from manual user configuration(s), which influences the automatic determination of the configuration. Consequently, an operator can achieve the desired configuration with the minimal set of inputs and with no requirement to fully understand the internal resources and limitations of the network device. In absence of any user configuration, the automatically generated configuration may be selected to achieve a default goal or a policy-based goal, such as to maximize the use of available resources, including hot-swappable hardware such as transceivers.

More particularly, embodiments in accordance with the present disclosure use a hierarchical representation of hardware resources, with defined relationships between tiers (levels) in the hierarchy, to resolve an L1 configuration. Resource allocation can be governed by rules and the interactions between the tiers. In some embodiments, the rules are not reliant on the type or order of the resources. Thus, the allocation of resources can be both consistent and understandable (e.g., through a displayable resource hierarchy) regardless of the resources available on a specific hardware device.

A single or small number of manually configured L1 configuration parameters can be added to the hierarchical representation and act to constrain the automatic configuration of other L1 configuration parameters in a manner that matches the user's intent. The resolution of automatically configured L1 configuration parameters may be driven by a configuration policy.

For context, a network device may have an arbitrarily complex topology that includes various hardware components that operate at L1. Examples of such components include, but are not limited to, switching chips (e.g., switching application specific integrated circuits (ASICs)), which may include one or more cores. The switching chips may be connected to front ports either directly or through intermediate chips that provide various functionality. Each port may comprise a front panel opening with one or more electrical lanes (referred to as transceiver or XCVR lanes), which, in some network devices, are configured via one or more interfaces (port interfaces), where a port interface on a port is a logical handle used to configure one or more electrical lanes on the port. The ports of a network device may be single lane ports which only have a single port interface on them, multi lane ports that can be broken out into multiple lower-speed port interfaces, or a mix of both.

The L1 topology of the network device is known to the device manufacturer. Some network device operating systems provide functionality to build a hierarchical model of the device's topology. This topology can be used as the basis for an automatic configuration graph for automatically configuring L1 configuration parameters.

A network device may have any number of hardware resources that can be configured via L1 configuration parameters. Table 1 below provides some non-limiting examples of L1 configuration parameters for network devices. The L1 configuration parameters used for a given implementation will depend on the capabilities of the underlying resources and thus various embodiments may use alternative L1 configuration parameter sets.

TABLE 1

| L1 Configuration | |
|---|---|
| parameter | Description |
| Interface Speed | The data rate of the port interface. |
| | Port interface data rates are often expressed in |
| | Gbps and number of XCVR lanes. For example, a |
| | speed of 100 G-2 specifies a port interface speed |
| | of 100 Gbps using two XCVR lanes each at 50 Gbps. |
| FEC (forward | A FEC mode (FEC encoding) to be used for the port |
| error correction) | interface. |
| Breakout Mode | The number of transceiver (XCVR) lanes allocated to |
| | each port interface. For flexible lane port with four |
| | XCVR lanes, example breakout modes include: |
| | 1-way: all four lanes allocated to a single port |
| | interface; |
| | 2-way: two lanes are allocated to one port interface |
| | and two lanes are allocated to another port interface. |
| | 3-way: one port interface is allocated two lanes and |
| | two additional port interfaces are allocated one |
| | lane each. |
| | 4-way: each of four port interfaces is allocated a |
| | single lane. |
| Logical Ports | This maximum number of interfaces that are allowed |
| | to be active within a logical port pool. |
| PLL Speed | The speed of a PLL. The PLL speed is expressed |
| Setting | herein in terms of a data rate (in Gbps) of |
| | individual lanes driven by the PLL. For example, |
| | a PLL speed of 50 G refers to a PLL setting to |
| | drive the XCVR lanes of the interfaces assigned |
| | to the PLL at a 50 G data rate. |
| | Some hardware components may include multiple |
| | PLLs that are configured as part of a port group. |
| | Thus, the PLL Speed setting may include a speed |
| | for each of the PLLs. |

The L1 configuration parameters for a network device may be overlaid onto the L1 component hierarchy depending on the components they primarily affect to create a hierarchical graph (resource hierarchy) of the configurable L1 hardware resources of the network device, where the resource hierarchy is based on the L1 component topology of the network device.

The resource hierarchy may be used to drive an automatic configuration computation of configuration parameters of the network device. In particular, manual configuration parameters can be used to set fixed values in the resource hierarchy. The resource hierarchy can then be traversed to automatically configure the other configuration parameters in a manner that both honors the manual configuration and, in some embodiments, optimizes the other configuration parameters according to a configuration policy.

Embodiments in accordance with the present disclosure can thus greatly simplify network device configuration and allow users to achieve an optimal L1 configuration without requiring a complete understanding of the hardware resources and limitations.

In the following description, for purposes of explanation, numerous examples and specific details are set forth in order to provide a thorough understanding of embodiments in accordance with the present disclosure. Particular embodiments as expressed in the claims may include some or all of the features in these examples, alone or in combination with other features described below, and may further include modifications and equivalents of the features and concepts described herein.

### Network Device

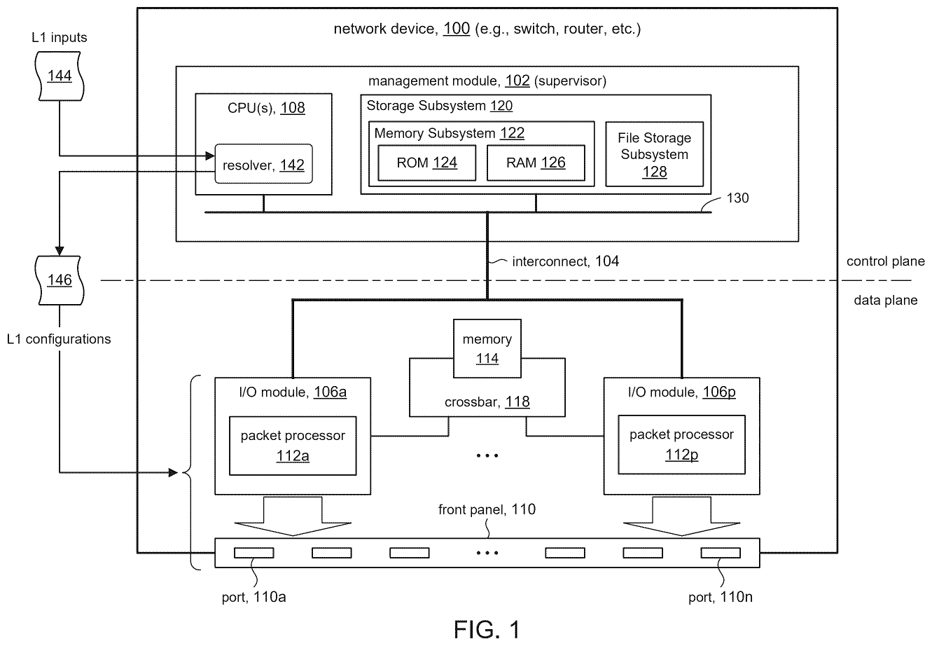

FIG. 1 is a schematic representation of a network device 100 (e.g., a router, switch, firewall, and the like) that can be adapted in accordance with the present disclosure. In some embodiments, for example, network device 100 can include one or more management modules (supervisors) 102, one or more I/O modules (switches, switch chips) 106a-106p, and a front panel 110 of I/O ports (physical interfaces, I/Fs) 110a-110n. Management module 102 can constitute the control plane of network device 100 (also referred to as the control layer or simply the central processing unit, CPU), and can include CPU(s) 108 for managing and controlling operation of network device 100 in accordance with the present disclosure. CPU(s) 108 can be a general-purpose processor, such as an Intel®/AMD® x86, ARM® microprocessor and the like, that operates under the control of software stored in a memory device/chips such as read-only memory (ROM) 124 or random-access memory (RAM) 126. The control plane provides services that include traffic management functions such as routing, security, load balancing, analysis, and the like.

CPU(s) 108 can communicate with storage subsystem 120 via bus subsystem 130. Other subsystems, such as a network interface subsystem (not shown in FIG. 1), may be on bus subsystem 130. Storage subsystem 120 can include memory subsystem 122 and file/disk storage subsystem 128. Memory subsystem 122 and file/disk storage subsystem 128 represent examples of non-transitory computer-readable storage devices that can store program code and/or data, which when executed by CPU(s) 108, can cause CPU(s) 108 to perform operations in accordance with the present disclosure. In some embodiments, for example, CPU(s) 108 can be configured to run a configuration resolver 142. Configuration resolver 142 can operate in accordance with the present disclosure to receive Layer 1 inputs 144 and produce a Layer 1 configuration 146 comprising configuration data used to program the Layer 1 resources in the data plane.

Memory subsystem 122 can include a number of memories such as main RAM 126 (e.g., static RAM, dynamic RAM, etc.) for storage of instructions and data during program execution, and ROM (read-only memory) 124 on which fixed instructions and data can be stored. File storage subsystem 128 can provide persistent (i.e., non-volatile) storage for program and data files, and can include storage technologies such as solid-state drive and/or other types of storage media known in the art.

CPU(s) 108 can run a network operating system stored in storage subsystem 120. A network operating system is a specialized operating system for network device 100. For example, the network operating system can be the Arista EOS® operating system, which is a fully programmable and highly modular, Linux-based network operating system developed and sold/licensed by Arista Networks, Inc. of Santa Clara, California. It is understood that other network operating systems may be used.

Bus subsystem 130 can provide a mechanism for the various components and subsystems of management module 102 to communicate with each other as intended. Although bus subsystem 130 is shown schematically as a single bus, alternative embodiments of the bus subsystem can utilize multiple buses.

The one or more I/O modules 106a-106p can be collectively referred to as the data plane of network device 100 (also referred to as the data layer, forwarding plane, etc.). Interconnect 104 represents interconnections between modules in the control plane and modules in the data plane. Interconnect 104 can be any suitable bus architecture such as Peripheral Component Interconnect Express (PCIe), System Management Bus (SMBus), Inter-Integrated Circuit (I2C), etc.

I/O modules 106a-106p can include respective packet processing hardware including packet processors 112a-112p (collectively 112) to provide packet processing and forwarding capability and supporting circuitry (not shown) such as PLLs, SerDes, etc. Each I/O module 106a-106p can be configured to communicate over one or more ports 110a-110n on the front panel 110 to receive and forward network traffic. Packet processors 112 can comprise hardware (circuitry), including for example, data processing hardware such as an application specific integrated circuit (ASIC), field programmable gate array (FPGA), processing unit, and the like, which can be configured to operate in accordance with the present disclosure. Packet processors 112 can include forwarding lookup hardware such as, for example, but not limited to content addressable memory such as ternary CAMs (TCAMs) and auxiliary memory such as static RAM (SRAM).

Memory hardware 114 can include buffers used for queueing packets. I/O modules 106a-106p can access memory hardware 114 via crossbar 118. It is noted that in other embodiments, the memory hardware 114 can be incorporated into each I/O module. The forwarding hardware in conjunction with the lookup hardware can provide wire speed decisions on how to process ingress packets and outgoing packets for egress. In accordance with some embodiments, some aspects of the present disclosure can be performed wholly within the data plane.

In accordance with the present disclosure, the configuration resolver 142 is an automated process that configures the Layer 1 (L1) resources of a network device (e.g., 100, FIG. 1). Layer 1 refers to the physical components of the network device, including their interconnections. A hardware resource (resource) is a configurable/specifiable L1 component; e.g., a phase-locked loop (PLL, its frequency is a configuration parameter that can specified), a port (the total number of data lanes is a configuration parameter that can be specified), an interface (its bandwidth is a configuration parameter that can be specified), and so on. Additional examples of configuration parameters are shown in Table 1 above.

In the context of the present disclosure, a hardware resource also refers to individual instances of an L1 component. For example, a port is a hardware resource. A network device can be configured with some number of ports (e.g., 64 ports); each port (instance) is referred to as a hardware resource.

### Resource Hierarchy

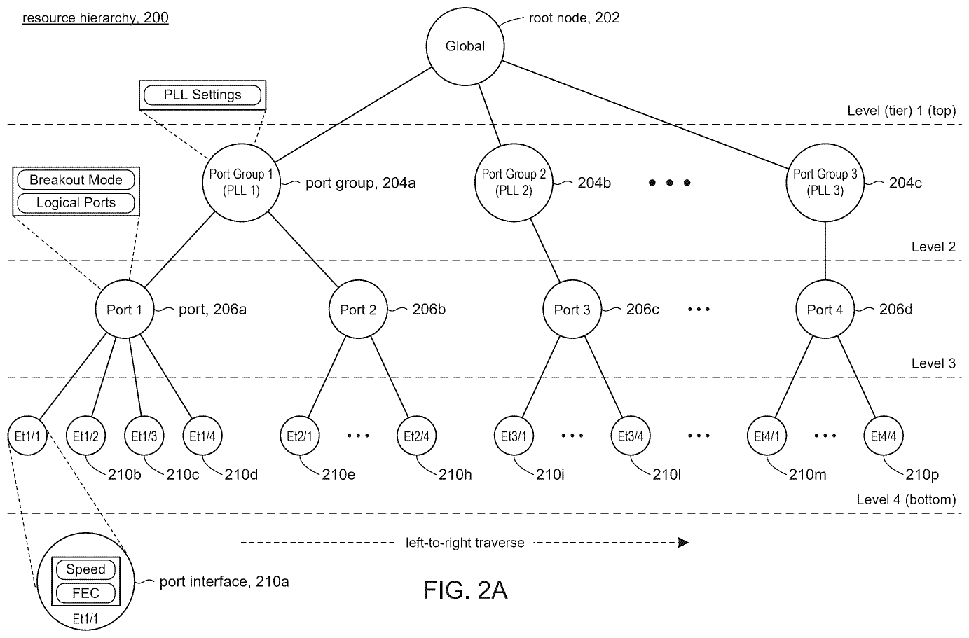

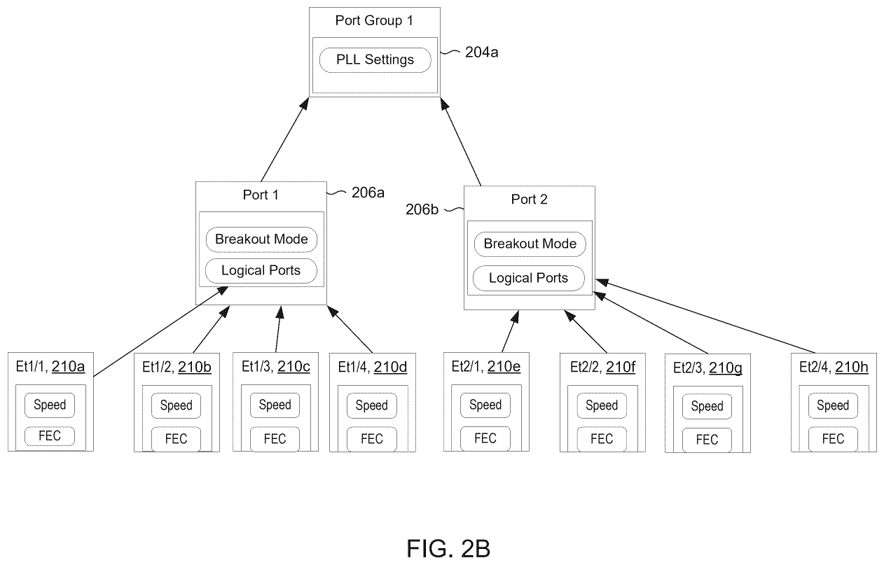

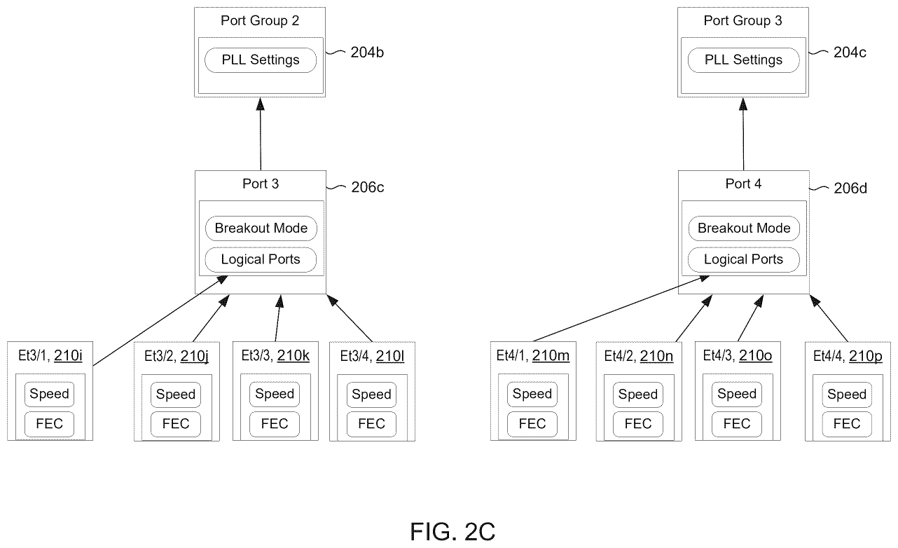

FIG. 2A is a diagrammatic representation of a resource hierarchy 200 of L1 hardware resources in a network device in accordance with some embodiments. FIG. 2B and FIG. 2C illustrate additional detail in portions of resource hierarchy 200. Resource hierarchy 200 may be provided by the network device manufacturer. In some embodiments, resource hierarchy 200 may be generated by overlaying the known L1 configuration parameters of a system on a hierarchical model (topology) of the network device with the configuration parameters being mapped to the hardware resources that they primarily affect. As shown in FIG. 2A, the data structure used to represent resource hierarchy 200 is a tree structure. It can be appreciated that in general any suitable data structure can be used to represent resource hierarchy 200.

Resource hierarchy 200 comprises nodes and connections between nodes. Resource hierarchy 200 includes a root node 202. Each node represents an instance of a particular hardware resource that is independently configurable; e.g., each instance of interfaces, namely Et1/1, Et1/2, Et1/3, and Et1/4, is associated with a node. The nodes below root node 202 have configuration parameters with associated configurations that are enforceable upon the hardware resources of the network device. The configuration parameters for a node map to the configuration parameters of the underlying hardware resource instance represented by the node. In some embodiments, root node 202 also has configuration parameters with enforceable configurations. Because there is a one-to-one correspondence between a node and the resource instance that the node represents, terms such as “node,” “resource,” “resource node,” “parent resource,” “child resource” and the like will be used interchangeably.

The edges (arrows) denote that configurations between two nodes may be interdependent. For instance, the PLL Settings configuration parameter (e.g., in the Port Group 1 node, 204a) and the Breakout Mode parameter (e.g., in the Port 1 node, 206a) are interdependent. Likewise, Breakout Mode is interdependent with the Interface Speed configuration parameters (e.g., in the port interface nodes, 210a-210d).

In some embodiments, a node may have several independently configurable configuration parameters where only some of those parameters are interdependent on the configuration of a related node. For example, if the PLL parameter (e.g., in the Port Group 1 node, 204a) is set for 10 Gbps operation, then the Breakout Mode in a child node (e.g., Port 1 node, 206a) settings would be constrained to single lane (4-way) configuration or a quad lane (1-way) configuration. On the other hand the Logical Ports parameter (e.g., in the Port 1 node, 206a) and the PLL Settings parameter (e.g., in the Port Group 1 node, 204a) are not interdependent; i.e., independent of each other. The interdependencies between configuration parameters at different levels of the resource hierarchy may be defined, for example, in the resource hierarchy itself or through the traversal rules. Even though some resource configurations do not affect others (e.g., “Logical Ports” and “FEC”) they can still be placed with the hierarchical structure such that the order in which they are computed is well known and deterministic.

As shown in FIGS. 2A, 2B, and 2C, resource hierarchy 200 includes a global root node 202, port group node 204a, port group node 204b, port group node 204c, port node 206a, port node 206b, port node 206c, port node 206d and port interface nodes 210a, 210b, 210c, 210d, 210c, 210f, 210g, 210h, 210i, 210j, 210k, 210l, 210m, 210n, 210o and 210p.

In one instance for example, global node 202 represents an ASIC. While, in FIG. 2A, global node 202 does not include L1 configuration parameters, it may be included in resource hierarchy 200 for purposes of visualization or traversal. In other embodiments, global node 202 may include L1 configuration parameters.

Each port group node 204a-204c maps to a configurable hardware resource that includes a PLL to drive a set of ports/port interfaces. The port group node examples shown in FIGS. 2B and 2C, each represents a single PL; although it will be appreciated that more generally a port group node can represent one or more PLLs. The port group nodes 204a-204c include per-port group L1 configuration parameters. Port nodes 206a-206d represent the configurable ports of the network device and hold per-port L1 configuration parameters. Port interface nodes 210a-210p represent the configurable port interfaces on the front panel ports of the network device and hold the per-port interface L1 configuration parameters. As mentioned above, a port interface on a port is a logical handle used to configure one or more electrical lanes on the port.

In general then, the lowest level (Level 4) of resource hierarchy 200 represents the L1 configuration parameters that can be configured on a per-port interface basis; that is, the port interface nodes 210a-210p at the lowest level of resource hierarchy 200 include the per port-interface L1 configuration parameters. The L1 configuration parameters at higher levels of resource hierarchy 200 represent resources that potentially affect progressively more interfaces.

Each configuration parameter of a node has a corresponding domain (space) of valid values (settings) based on the underlying hardware. The configuration domain represents the set of valid values for a given configuration parameter, which can be expressed as ranges of values, minimum and/or maximum values, an enumerated list of valid values, and so on. For purposes of discussion, Table 2 below provides examples of configuration domains for L1 configuration parameters of the nodes of the example resource hierarchy 200 illustrated in FIGS. 2A, 2B and 2C. The notation for the interface speed parameter values has the following format:
<totalBandwidth>-<numberOfLanesUsed>
   where, for example, the configuration “100G-2” can be read as “the interface is configured with 2 lanes and operates at 100 Gbps data speed”.

TABLE 2

| | Configuration | |
|---|---|---|
| Node/Resource | parameter | Configuration Domain (Space) |
| Port Group 1 | PLL Setting | 50 G, 25 G, 10 G, |
| (204a, FIG. 2B) | | |
| Port 1 | Breakout | 1-way, 2-way, 3-way, 4-way |
| | Mode | |
| Et1/1 | Interface | 200 G-4, 100 G-4, 40 G-4, 100 G-2, |
| | Speed | 50 G-2, 50 G-1, 25 G-1, 10 G-1 |
| Et1/2 | Interface | 50 G-1, 25 G-1, 10 G-1 |
| | Speed | |
| Et1/3 | Interface | 100 G-2, 50 G-2, 50 G-1, 25 G-1, |
| | Speed | 10 G-1 |
| Et1/4 | Interface | 50 G-1, 25 G-1, 10 G-1 |
| | Speed | |
| Port 2 | Breakout | 1-way, 2-way, 3-way, 4-way |
| | Mode | |
| Et2/1 | Interface | 200 G-4, 100 G-4, 40 G-4, 100 G-2, |
| | Speed | 50 G-2, 50 G-1, 25 G-1, 10 G-1 |
| Et2/2 | Interface | 50 G-1, 25 G-1, 10 G-1 |
| | Speed | |
| Et2/3 | Interface | 100 G-2, 50 G-2, 50 G-1, 25 G-1, |
| | Speed | 10 G-1, |
| Et2/4 | Interface | 50 G-1, 25 G-1, 10 G-1 |
| | Speed | |
| Port Group 2 | PLL Setting | 50 G, 25 G |
| (204b, FIG. 2C) | | |
| Port 3 | Breakout | 1-way, 2-way, 3-way, 4-way |
| | Mode | |
| Et3/1 | Interface | 400 G-4, 200 G-4, 100 G-4, |
| | Speed | 100 G-2, 50 G-2, 100 G-1, 50 G-1 |
| Et3/2 | Interface | 100 G-1, 50 G-1 |
| | Speed | |
| Et3/3 | Interface | 100 G-2, 50 G-2, 100 G-1, 50 G-1 |
| | Speed | |
| Et3/4 | Interface | 100 G-1, 50 G-1 |
| | Speed | |
| Port Group 3 | PLL Setting | 50 G, 25 G |
| (204c, FIG. 2C) | | |
| Port 4 | Breakout | 1-way, 2-way, 3-way, 4-way |
| | Mode | |
| Et4/1 | Interface | 400 G-4, 200 G-4, 100 G-4, |
| | Speed | 100 G-2, 50 G-2, 100 G-1, 50 G-1 |
| Et4/2 | Interface | 100 G-1, 50 G-1 |
| | Speed | |
| Et4/3 | Interface | 100 G-2, 50 G-2, 100 G-1, 50 G-1 |
| | Speed | |
| Et4/3 | Interface | 100 G-1, 50 G-1 |
| | Speed | |

### Configuration Resolver

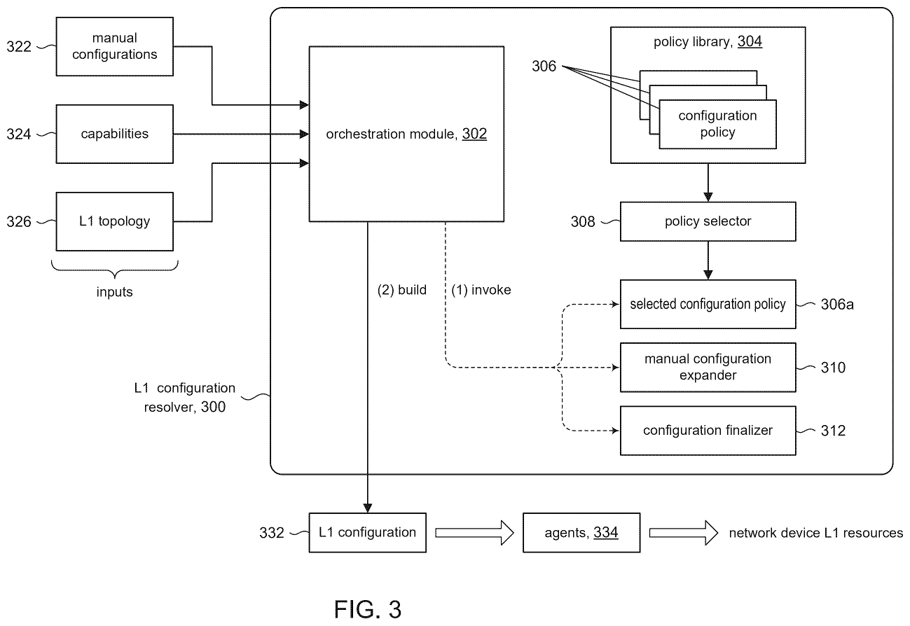

FIG. 3 shows a high-level representation of an L1 configuration resolver 300 in accordance with the present disclosure. Configuration resolver 300 is operable to build an L1 configuration 332 to configure various hardware components of network device 100. FIG. 3 further shows configuration agents 334 running on network device 100 may use L1 configuration 332 to configure the hardware components of the network device. The processing of configuration resolver 300 and configuration agents 334 may be performed in the control plane of the network device. By way of example, configuration resolver 300 and configuration agents 334 may be implemented as part of the network device's operating system. In some embodiments, the network device can include one or more processing units (circuits), which when operated, can cause the network device to perform processing in accordance with the flow of operations disclosed herein. Processing units (circuits) in the control plane, for example, can include general CPUs that operate by way of executing computer program code stored on a non-transitory computer readable storage medium (e.g., read-only memory); e.g., CPU 108 in the control plane (FIG. 1) can be a general CPU.

In some embodiments, configuration resolver 300 can include orchestration module 302, policy library 304, policy selector 308, manual configuration expander 310, and a configuration finalizer 312. Inputs to configuration resolver 300 can include manual (user-specified) configurations 322, capabilities 324, and Layer 1 (L1) topology 326. An output of configuration resolver 300 is L1 configuration data 332 which can be used to configure the actual physical hardware resources of the network device.

Manual configurations 322—Manual configurations represent the user's intended/desired configuration of certain components of the network device. As explained below, embodiments in accordance with the present disclosure automatically compute or otherwise determine the configuration parameters of the hardware resources of the network device to work with the user's specified configuration settings. Stated differently, manual configurations serve as constraints for automatically computing or determining the parameters of other resources in the network device.

Manual configurations include any configurations of the resources in the network device that a user can specify; e.g., the data rate of a port, the number of lanes to allocate to a port, and so on. For example, if the user wants specific ports on the network device to operate at specific data rates, the user can input their configuration via a suitable interface such a command line interface (CLI), from a data file, and so on. The user-specified configuration can be provided to configuration resolver 300 as manual configurations 322 and added to resource hierarchy 200 as fixed values.

Capabilities 324—Capabilities refer to valid values for individual components (hardware resources) such as ASIC core, gearbox, transceivers, etc. of the network device. As noted above in connection with Table 2, the set of valid values of a component are referred to as the configuration domain or configuration space of a component and can be expressed as ranges of values, minimum and/or maximum values, an enumerated list of valid values, and so on. For example, a PHY core has a set number of physical data lanes, which can be configured individually or grouped into a logical interface that runs at a particular speed (or bandwidth). As another example, FEC capability of the PHY belonging to an interface can be configured for encodings such as Reed-Solomon, Fire-Code, and the like.

L1 topology 326—The L1 topology refers to the topology of a given network device. The L1 topology describes the physical and functional interconnectivity among all the hardware resources in the network device; e.g., which lanes (data paths) on the PHY cores are connected to the ASICs, which lanes on the transceivers are connected to the ASIC, which PLLs are connected to which transceivers, and so on.

Orchestration module 302 receives inputs 322, 324, 326 and coordinates the flow of the input data among the modules 310, 312 to automate the generation (build) of configuration data 332 in accordance with the selected configuration policy 306a.

Policy library 304 can store one or more configuration policies 306. The configuration policies 306 comprise heuristics (rules) to automatically configure the hardware resources. In accordance with the present disclosure, configuration policy 306 can include rules, algorithms, etc. that specify how to compute or otherwise determine values for the configuration parameters in resource hierarchy 200, taking into consideration any user-specified parameters specified in manual configurations 322. The end result of processing in accordance with configuration policy 306 can be a fully specified L1 configuration of the hardware components of the network device.

The heuristics for a configuration policy 306 are tuned for particular use cases, such as providing rules for prioritization and handling conflicts. For example, one policy may favor interface speed while another policy may prioritize the number of active interfaces. As such, the policies can affect how the nodes prioritize possible configurations when reporting configurations to higher level nodes and/or how a node selects a configuration from the configuration space taking into account factors such as conflicts, resource starvation, and the like.

Policy selector 308 allows for a configuration policy to be selected from the policy library 304. In some embodiments, the selected configuration policy 306a can be specified based on the target customer; e.g., a datacenter, campus, etc. In other embodiments, a user (e.g., network administrator) in the datacenter can select the configuration policy.

Manual configuration expander 310—The user-specified manual configuration is generally likely to be expressed in human-readable format. Manual configuration expander 310 can convert human-readable manual configurations into an internal machine-readable format that is suitable for the automated configuration processing of the present disclosure.

Configuration finalizer 312—The configuration parameters computed and stored in the resource hierarchy generally need to be converted to a suitable format in order to configure or otherwise program the actual hardware resources. Configuration finalizer 312 can convert the computed configuration parameters into a suitable representation and generate configuration data 332 that represents the final or complete switch configuration data. The configuration data 332 can be consumed by configuration agents 334 running on the network device to configure (e.g., program, set registers, etc.) the actual hardware resources.

The heuristics in a given selected configuration policy 306a will vary from one policy to another. Following is a sampling of rules that can be represented by a configuration policy, explained with reference to the examples shown in FIGS. 2A-2C:
Any configuration of the configured configuration parameter is binding on lower-level (descendants: child, grandchild, etc.) configurations in the hierarchy. For example, the configuration of Port Group 1 is binding on Port 1, Port 2, Et1/1, Et1/2, Et1/3, Et1/4, Et2/1, Et2/2, Et2/3, and Et2/4, the configuration of Port 1 is binding on Et1/1, Et1/2, Et1/3, Et1/4, and the configuration of Port 2 is binding on Et2/1, Et2/2, Et2/3, and Et2/4, and so on.
An automatic configuration parameter is bound by lower-level (child, grandchild, etc.) manual configurations. For example, the configuration of Port Group 1 is bound by any manual configuration of Port 1, Port 2, Et1/1, Et1/2, Et1/3, Et1/4, Et2/1, Et2/2, Et2/3, or Et2/4, the configuration of Port Group 2 is bound by any manual configuration of Port 3, Et3/1, Et3/2, Et3/3, Et3/4, the configuration of Port Group 3 is bound by any manual configuration of Port 4, Et4/1, Et4/2, Et4/3, Et4/4, configuration of Port 1 is bound by any manual configuration of Et1/1, Et1/2, Et1/3, Et1/4, the configuration of Port 2 is bound by the manual configuration of Et2/1, Et2/2, Et2/3, or Et2/4, the configuration of Port 3 is bound by any manual configuration of Et3/1, Et3/2, Et3/3, Et3/4, and the configuration of Port 4 is bound by any manual configuration of Et4/1, Et4/2, Et4/3, Et4/4.
If the configuration process encounters resource contention for a configuration parameter, the configuration process attempts to adjust the confirmation parameter in a manner that honors all other resolved configurations on higher priority interfaces. According to one embodiment, a lower numbered interface has a higher priority than a higher numbered interface.
   The foregoing rules apply to resolving interdependent parameters. Other rules may apply to parameters that are not interdependent with other levels of the hierarchy. The foregoing rules are provided by way of example and are not intended to be limiting. It will be appreciated that other rules may be applied to resolving interdependent parameters.

### Processing of the Configuration Resolver

The discussion will now turn to a description of processing in the configuration resolver 300 in accordance with some embodiments of the present disclosure.

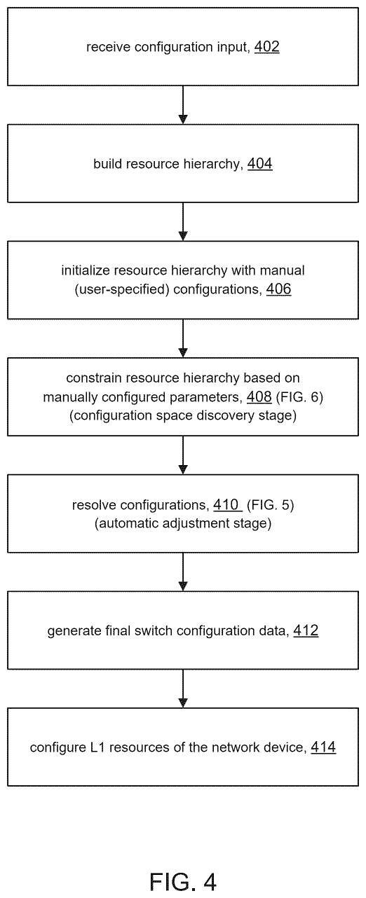

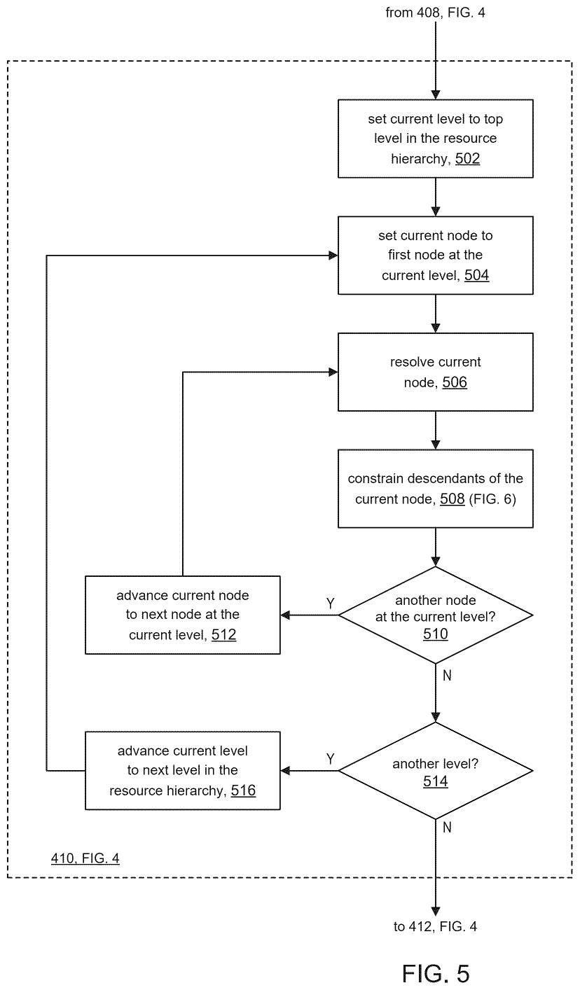

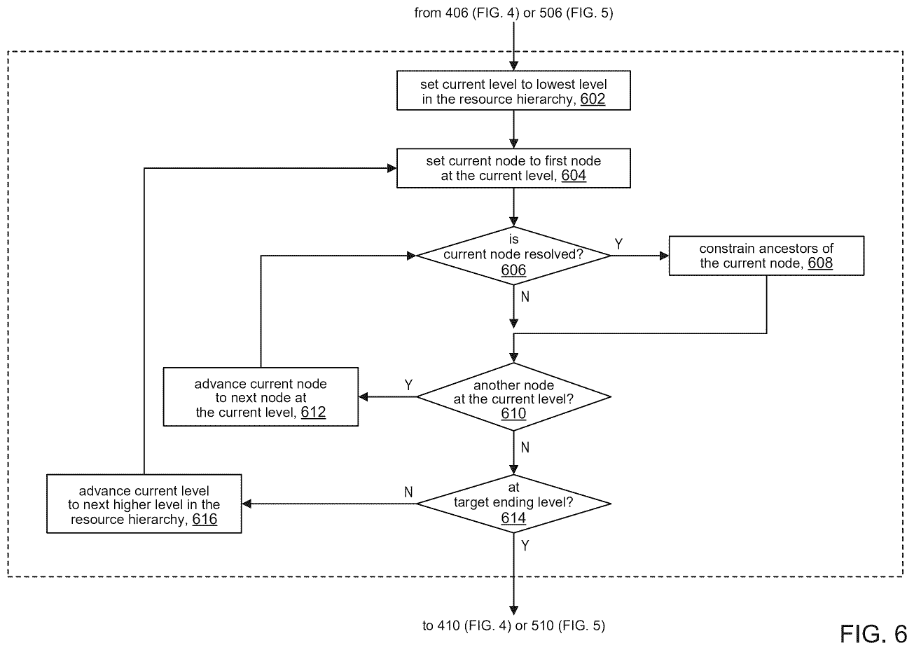

Referring to FIG. 4, the configuration process in accordance with some embodiments involves two stages of traversal through resource hierarchy 200: (1) configuration space discovery and (2) automatic adjustment. Embodiments in accordance with the present disclosure utilize the resource hierarchy 200 as an automatic configuration computation hierarchy to automatically configure the L1 configuration parameters to match the operator's intent for the network device.

At operation 402, the network device can receive configuration input to drive the automated configuration process in accordance with the present disclosure. In some embodiments, for example, configuration input can include the inputs shown and described in connection with FIG. 3, including manual configurations 322, capabilities 324, and an L1 topology 326.

At operation 404, the network device can build resource hierarchy 200 based on the L1 topology (e.g., L1 topology 326) of the device. This is a hierarchical representation of the configurable resources that constitute the network device. Each node in the hierarchy represents an instance of a resource. The resource hierarchy represents the configuration interdependencies among the resources. The L1 topology provides the connections between instances of resources (nodes) in the resource hierarchy.

At operation 406, the network device can initialize nodes in the resource hierarchy with manual (user-specified) configuration parameters of the hardware resources, if any. For a given resource, the user can specify some or all of its configuration parameters. In some embodiments, for example, the network device can traverse the resource hierarchy to visit each node in the resource hierarchy. If there are any user-specified values for the configuration parameters for the visited node, then those configuration parameters are set according to the user-specified values.

Manually configured parameters represent the user's intent on how the user wants the resource to operate. As such, in accordance with the present disclosure, the user's specified configuration of L1 hardware resources in a network device can be treated as fixed values and are not modified by the automation. The user-specified configurations can drive the automated configuration of the remaining hardware resources in the network device. The user-specified configurations can serve as a basis for constraining or otherwise influencing the automated computation of the configuration parameters.

At operation 408, the network device can traverse the resource hierarchy to constrain the values of one or more configuration parameters of resources in the resource hierarchy based on any manually configured resources made by a user. As explained above, the configuration parameters of the resources in the resource hierarchy, each, have a configuration space (e.g., from capabilities 324, FIG. 3) of valid values or settings. A configuration parameter can be referred to as being “resolved” when a value for the parameter has been computed. A resolved configuration parameter is treated as a fixed parameter. In accordance with the present disclosure, manually configured parameters are deemed to be “resolved” because they represent the user's intent and should be treated as fixed values and should not be modified by the automated configuration process (operation 410). Further in accordance with the present disclosure, a configuration parameter can be deemed to be “resolved” when the automation has computed a value for the parameter.

When a configuration parameter is resolved, the resolved parameter may constrain the configuration space of any parameters that are interdependent with the resolved parameter. Constraining the configuration space of a parameter refers to limiting the space of valid value with which the parameter can be configured. For example, if the user specifies a data rate for a port (child resource), the specified data rate can constrain or otherwise restrict the possible values for the frequency of the clock circuit (parent resource) that drives the port.

Operation 408 makes an initial pass through the resource hierarchy to constrain the configuration space of resources that may be affected by manually configured resources. In a sense, this operation can be viewed as discovering the configuration space for each of the resources in preparation for the automation in operation 410.

In accordance with the present disclosure, constraining the configuration space is a bottom-up process. The process begins at the lowest level in the resource hierarchy and proceeds up the resource hierarchy one level at a time to a target ending level. Details for the constraining operation in accordance with some embodiments of the present disclosure are described in connection with flow in FIG. 6. To initially constrain the resource hierarchy with the manually configured parameters, the operations in FIG. 6 are performed with the target ending level set to Level 1.

At operation 410, the network device can traverse the resource hierarchy to automatically compute configuration parameters of resources in the resource hierarchy. The network device can configure unconfigured resources, taking into consideration any previously resolved configured resources. The computations are automated in that configuration parameters are computed absent any user input other than any manually configured parameters.

At operation 412, the network device can traverse the resource hierarchy to generate configuration data (e.g., 332) that represents the final complete switch configuration data. In some embodiments, for example, the network device can visit each node in the resource hierarchy and collect and compile the various configuration parameters to generate suitable data used to configure the actual physical hardware resources of the network device.

At operation 414, the network device can configure its L1 hardware resources. In some embodiments, for example, the network device can invoke various agents (e.g., 334) that run on the network device to configure the various hardware resources using the configuration data generated at operation 412.

Referring to FIG. 5, the discussion will now turn to a high-level description of processing in a network device (e.g., 100, FIG. 1) for resolving the L1 hardware resources in accordance with the present disclosure. The flow of FIG. 5 represents an example of the automatic adjustment stage of the present disclosure. According to one embodiment, the automatic configuration process attempts to resolve the configuration parameters from the highest level of resource hierarchy 200 to the lowest level. It will be appreciated that traversal algorithms other than the one used in FIG. 5 can be employed to traverse resource hierarchy 200. For example, in some embodiments traversal can use algorithms that optimize on search time. In other embodiments, traversal can use algorithms that optimize space efficiency, and so on.

At operation 502, the network device can initialize some processing parameters. The flow proceeds in top-down fashion, starting with the highest (top) level in the resource hierarchy and generally working down the hierarchy one level at a time. In some embodiments, the network device can use a “current level” pointer which is a parameter that points to or otherwise references the current level in the resource hierarchy being processed. The network device can initialize the current level pointer to point to the top level of the resource hierarchy.

At operation 504, the network device can use a “current node” pointer which is a parameter that points to or otherwise references the node at the current level to be processed. The network device can initialize the current node pointer to reference the first node at the current level. Processing the nodes at a given level can proceed in any predefined order (e.g., left-to-right, right-to-left, etc.). In some embodiments, processing the nodes at a given level can proceed in left-to-right order. Accordingly, the first node can be the left-most node at the current level.

At operation 506, the network device can resolve the configuration parameters of the resource at the current node in accordance with the rules of the selected configuration policy 306a. In some embodiments, for example, computing the value for a configuration parameter can be based on the configuration space associated with that parameter and taking into consideration the available parameters of the children nodes (per the selected configuration policy 306a). Because the configuration space will already have been constrained by any manually entered configurations, the configuration parameters of the resource at the current node will already take into consideration those manual configurations, and so these configuration parameters can be deemed “resolved.”

At operation 508, the network device can constrain the nodes that descend from the current node. Suppose, for example, the current node is a PLL and its configuration parameter is set to 10 Gbps. The 10 Gbps setting of the PLL (parent) would limit the configuration space of the interface (child node) by imposing a maximum data rate on the interface. In general, setting the configuration parameters of a given node may limit the configuration space of its children nodes, which in turn may limit the configuration space of the children of those children nodes, and so on down the resource hierarchy.

Accordingly, in accordance with the present disclosure, the automated computations can include a round of constraining the configuration space of any unresolved configuration parameters of descendants of the current node. As explained above, constraining the configuration space is a bottom-up process. The process begins at the lowest level in the resource hierarchy and proceeds up the resource hierarchy one level at a time to a target ending level. Details for the constraining operation in accordance with some embodiments of the present disclosure are described in connection with flow in FIG. 6. In some embodiments, for example, the operations in FIG. 6 are performed with the target ending level set to the current level being processed.

At decision point 510, if there is another node at the current level, then processing can continue to operation 512. If there are no more nodes at the current level to configure, then processing can continue to operation 514.

At operation 512, the network device can advance the “current node” pointer to the next node at the current level, which in our example is the next node to the right. Processing can return to decision point 506 to process the next node at the current level in the resource hierarchy.

At decision point 514, if the current level is the bottom-most level in the resource hierarchy, then processing can be deemed complete. Otherwise, processing can continue to operation 516.

At operation 516, the network device can advance the “current level” pointer to the next level down in the resource hierarchy. Processing can return to operation 504 to process nodes in the next level in the resource hierarchy.

Referring to FIG. 6, the discussion will now turn to a high-level description of processing in a network device (e.g., 100, FIG. 1) to constrain the configuration space of one or more parameters in the resource hierarchy. As noted above when any configuration parameter of a node is resolved, this may constrain the configuration space of interdependent parameters.

It will be appreciated that traversal algorithms other than the one used in FIG. 6 can be employed to traverse resource hierarchy 200. For example, in some embodiments traversal can use algorithms that optimize on search time. In other embodiments, traversal can use algorithms that optimize space efficiency, and so on.

At operation 602, the network device can initialize some processing parameters. Generally, the flow proceeds in bottom-up fashion, starting with the lowest level in the resource hierarchy and working up the hierarchy one level at a time. In some embodiments, for example, the network device can use a “current level” pointer which is a parameter that points to or otherwise references the current level in the resource hierarchy being processed. The network device can initialize the current level pointer to point to the lowest level of the resource hierarchy. Using FIG. 2A as an example, for instance, the current level pointer can be initialized to Level 4, the lowest level in resource hierarchy 200.

At operation 604, the network device can use a “current node” pointer which is a parameter that points to or otherwise references the node to be processed at the current level. The network device can initialize the current node pointer to reference the first node at the current level. Processing the nodes at a given level can proceed in any predefined order (e.g., left-to-right, right-to-left, etc.). In some embodiments, processing the nodes at a given level can proceed in left-to-right order, as depicted in FIG. 2A for example. Accordingly, the first node can be the left-most node at the current level. Using FIG. 2A as our example, the current node pointer at Level 4 can be initialized to the left most node at Level 4, namely “Et1/1.”

At decision point 606, if the current node is resolved or at least partially resolved, the network device can proceed to operation 608. Stated differently, processing can continue at operation 608 if at least one configuration parameter of the resource associated with the current node is resolved. If none of the configuration parameters at the current node are resolved, then processing can continue to decision point 610.

At operation 608, in response to the current node being at least partially resolved, the network device can constrain the configuration parameters of the ancestor nodes (parent, grandparent, great grandparent, etc.) to propagate any effects of the resolved parameters up the resource hierarchy one level at a time to the “target ending level”. During the configuration space discovery stage, the target ending level is set at operation 408. Likewise, during the automatic adjustment stage, the target ending level is set at operation 508 in FIG. 5.

In accordance with the present disclosure, constraining a configuration parameter limits or otherwise restricts the configuration space of values to which the configuration parameter can be set. The configuration space can be constrained/limited, for example, by changing the minimum and/or maximum limits on a value (e.g., raising the minimum value, lowering the maximum values), changing the range of values (e.g., reducing the range), changing the allowable settings for an enumerated parameter (e.g., removing allowable settings), and so on.

Referring to FIG. 2A, for example, suppose node “Et1/4” is manually configured to operate at 10 Gbps. The manual configuration can be propagated up the resource hierarchy 200 as follows:
Consider the parent of “Et1/4”, namely “Port 1”, and constrain the parent based on the manual configuration of Et1/4, if needed.
Consider the parent of “Port 1”, namely “Port Group 1”, and constrain the parent based on any constrained parameters of Port 1, if needed.
Consider the parent of “Port Group 1”, namely “Global’, and constrain the parent based on any constrained parameters of Port Group 1, if needed.

At decision point 610, if there is another node at the current level, then processing can continue to operation 612. If there are no more nodes at the current level then processing at the current level can be deemed complete, and processing can continue to decision point 614.

At operation 612, the network device can advance the “current node” pointer to the next node at the current level, which in our example is the next node in the resource hierarchy to the right of the current node. Referring to FIG. 2A, for example, if the current level is Level 3 and the current node points to the “Port 2” node, then we would advance to the “Port 3” node on the next iteration. Processing can return to decision point 606 to process the next node.

At decision point 614, if the current level is not at the target ending level, then processing can continue to operation 616 to process the next level up. If the current level is at the target ending level, then the constraining operation can be deemed complete. Processing can continue processing at operation 410 (in the case of configuration discovery) or operation 510 (in the case of automatic adjustment).

At operation 616, the network device can advance the “current level” pointer to the next level up in the resource hierarchy. Processing can return to operation 604 to process nodes in the next level up in the resource hierarchy.

### Automatic Configuration Example

The discussion will now turn to an illustrative example of an automatic configuration session in the configuration resolver 300. With reference to FIGS. 2A to 2C and Table 2, the example will assume that interfaces Et1/3 and Et3/1 have been manually configured, and in particular we will assume for discussion purposes that Et1/3 is configured to 50G-1 and Et3/1 is configured to 100G-2.

### A. Configuration Space Discovery (Operation 408, FIGS. 4 and 5)

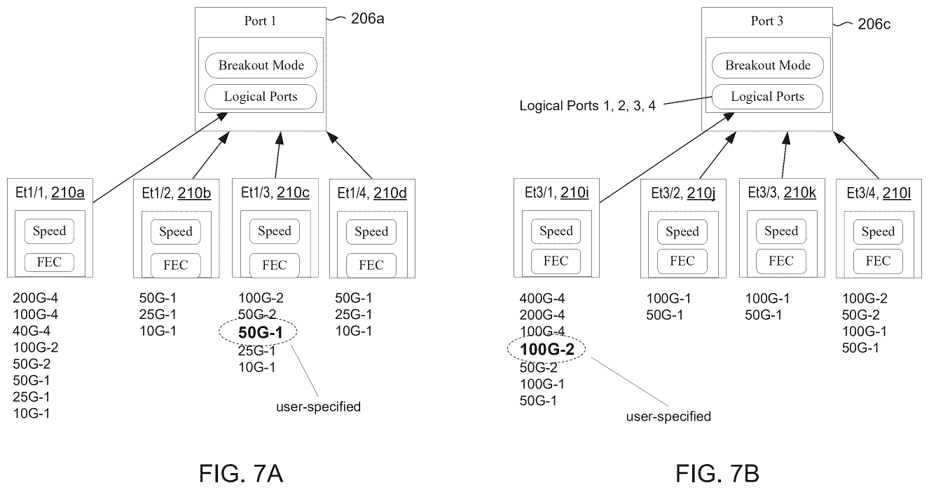

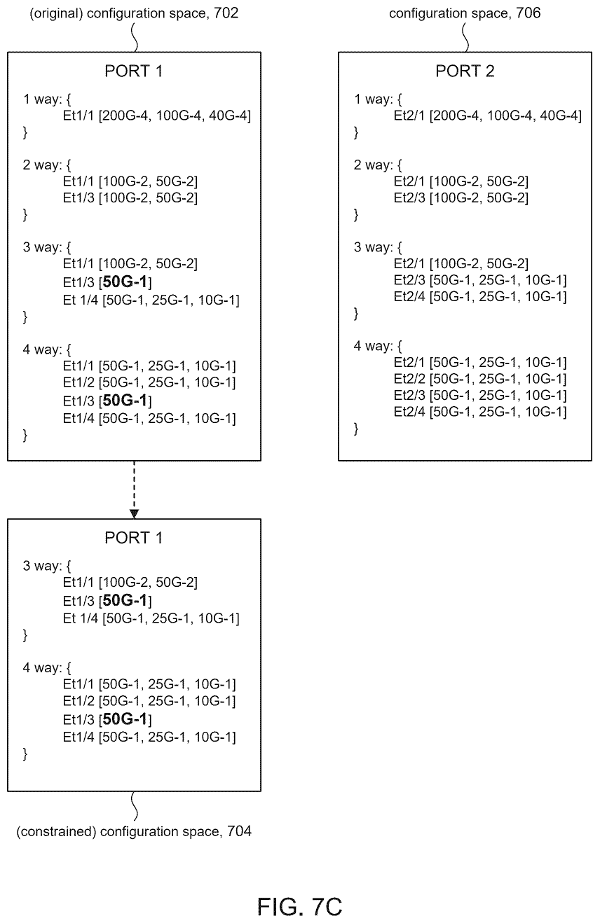

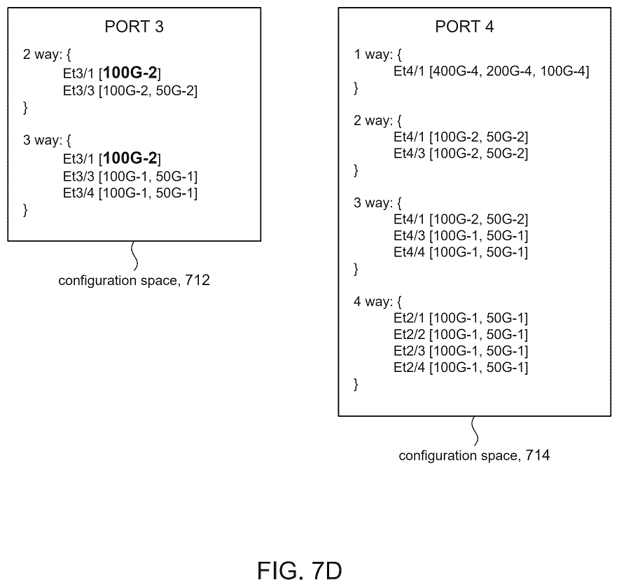

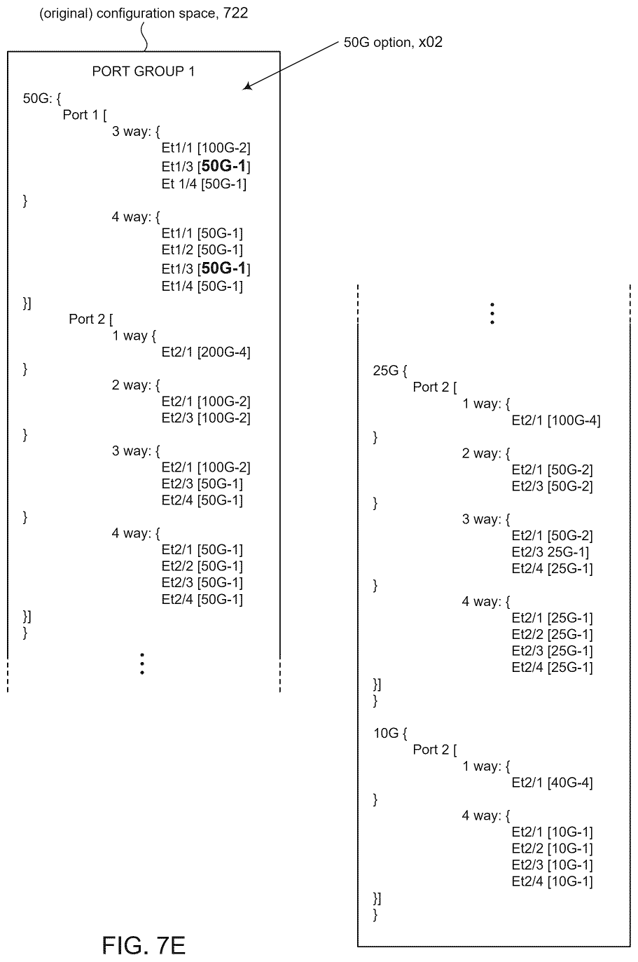

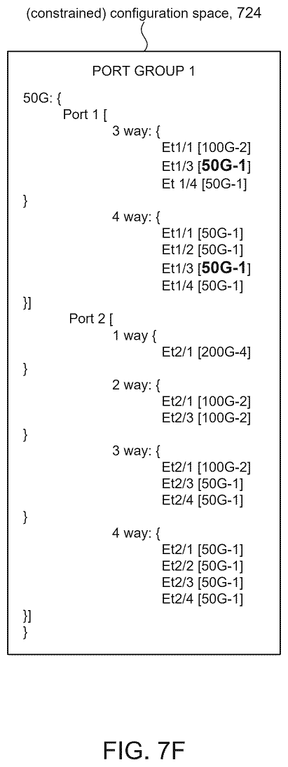

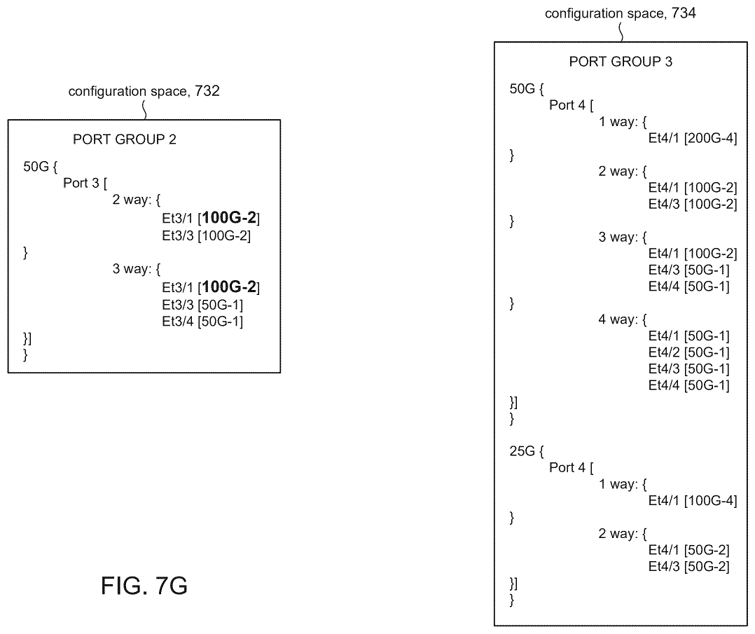

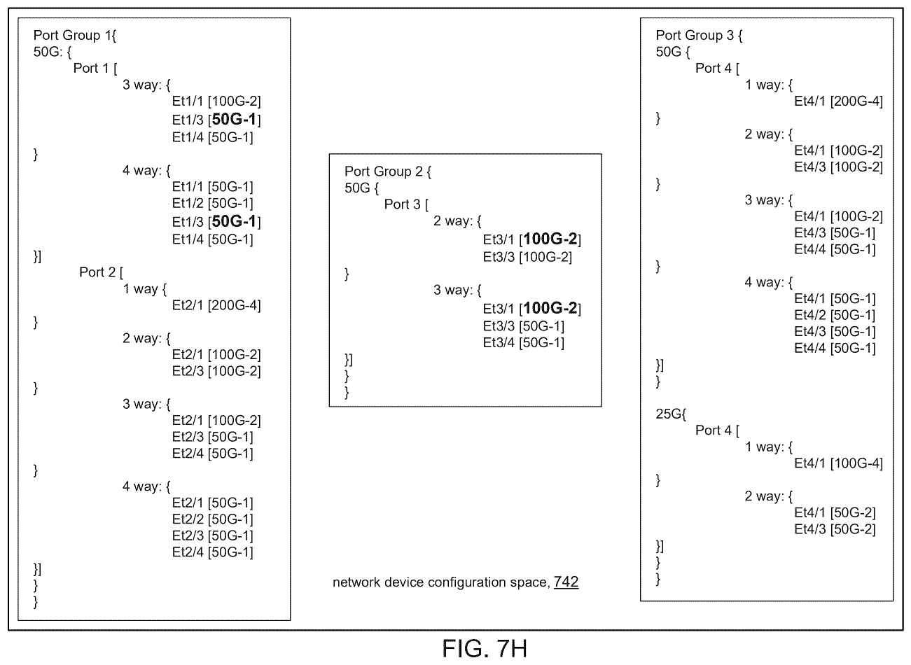

FIG. 7A shows an example in which the speed interface parameter of node 210c (Et1/3) is manually configured to 50G-1, and likewise FIG. 7B shows an example in which the speed interface parameter of node 210e (Et3/1) is manually configured to 100G-2. These values can be fixed (initialized) in resource hierarchy 300 (operation 406, FIG. 4).

Next, with reference to FIGS. 7C to 7H, we constrain the ancestor (higher-level) nodes (operation 408, FIGS. 4 and 5). This begins the configuration space discovery stage in the configuration resolver.

During configuration space discovery, each port interface node 210a-210p reports its possible configurations for its interface speed parameter to its respective parent node, port nodes 206a-206d. Referring to FIG. 7A, in response to the manual configuration of port interface Et1/3, interface node 210c (Et1/3) reports only the interface speed configuration of 50G-1 to port node 206a (Port 1) as the only candidate for speed selection, whereas interface node 210a (Et1/1), interface node 210b (Et1/2), and Interface node 210d (Et1/4) report all of their respective interface speed configurations to port node 206a (Port 1) as candidates for speed selection. Likewise, with reference to FIG. 7B, in response to port interface Et2/1 being manually configured, interface node 210i (Et3/1) reports only the interface speed configuration of 100G-2 to port node 206c (Port 3) as the only candidate for speed selection, whereas interface node 210j (Et3/2), interface node 210k (Et3/3), and Interface node 210l (Et3/4) report all of their respective interface speed configurations to port node 206c (Port 3) as candidates for speed selection.

With reference to FIG. 7C, at the higher-level node (the parent node), the possible configurations of the higher-level interdependent configuration parameter are paired with corresponding possible configurations reported for the lower-level interdependent configuration parameter by the lower-level node. For example, at port node 206a (Port 1), possible configurations reported by interface nodes 210a-210d are matched to compatible breakout modes: 1-way, 2-way, 3-way, 4-way. FIG. 7C illustrates an example of overall configuration space 702 of the paired configurations at port node 206a for Port 1 based on the reporting from the children port interface nodes 210a-210d.

According to one embodiment, the configuration domain of the higher-level interdependent configuration parameter (e.g., Breakout Mode) at the parent node (e.g., port node 206a for Port 1) and the reported possible configurations for the lower-level interdependent configuration parameter (e.g., Interface Speed) reported by the child node(s) (e.g., port interface nodes 210a-210d) are mapped to a compatibility matrix for the interdependent parameters. The solution space of the compatibility matrix can be determined, which represents a constrained configuration space.

Continuing with the previous example, at port node 206a for Port 1, only the 3-way breakout mode and the 4-way breakout mode are consistent with the manual configuration of 50G-1 for interface Et1/3. Accordingly, the original configuration space 702 can thus be constrained resulting in constrained configuration space 704, which is the solution space of a compatibility matrix that honors the manual configuration from child interface node 210c for Et1/3. FIG. 7C also shows an example configuration space 706 for port node 206b (Port 2) after port interface nodes 210e-210h report previously constrained interface speed configurations for respective interfaces Et2/1, Et2/2, Et2/3, Et2/4.

FIG. 7D illustrates a configuration space 712 for port node 206c (Port 3) and a configuration space 714 for port node 206d (Port 4) once the respective child interface nodes have reported their constrained configuration space. Note that configuration space 712 is constrained to have only the 2-way and 3-way breakout modes because of the manual configuration on Et3/1.

The port nodes 206a-206d then report to their respective parent nodes. Port node 206a (Port 1) and port node 206b (Port 2) report the possible configurations in respective configuration space 704 (FIG. 7C) and configuration space 706 (FIG. 7C) to the port group node 204a (Port Group 1). Port node 206c (Port 3) reports the possible configurations in configuration space 712 (FIG. 7D) to the port group node 204b (Port Group 2) and the port node 206d (Port 4) reports the possible configurations in configuration space 714 (FIG. 7D) to port group node 204c (Port Group 3).

As the possible set of configurations get passed from the lower-level port node 206 to the respective higher-level port group node 204, the configurations are split up and the possible configurations of the higher-level node are paired with corresponding lower-level configurations. Again, a solution space of compatible configurations can be determined for the parent node. FIG. 7E illustrates an example configuration space 722 for port group node 204a for Port Group 1, with the possible configurations from configuration space 704 (FIG. 7C) and configuration space 706 (FIG. 7C) paired with the corresponding possible PLL speed settings for Port Group 1. Configuration space 722 can be reduced to configuration space 724 of FIG. 7F of configurations constrained by the manual interface selection on Et1/3.

FIG. 7G illustrates an example configuration space 732 for the port group node 204b for Port Group 2 with the possible configurations from configuration space 712 (FIG. 7D) paired with the corresponding possible PLL speed configurations of Port Group 2. FIG. 7F also illustrates an example configuration space 734 for the port group node 204c for Port Group 3 with the possible configurations from configuration space 714 (FIG. 7D) paired with the corresponding possible PLL speed configurations of Port Group 3.

FIG. 7H illustrates an example of a constrained configuration space (discovered configuration space) 742 for the network device where the constrained configuration space honors the user's manual configurations of Et1/3 and Et3/1.

### B. Automatic Configuration (Operation 410, FIGS. 4 and 6)

Having determined the constrained configuration space for the network device, the configuration resolver can commence the next stage of processing, namely automatic configuration. As noted above the configuration process is driven by the heuristics in the selected configuration policy (e.g., 306a, FIG. 3). The heuristics can include rules to optimize performance, resolve conflicts, and so on.

In the example of resource hierarchy 200, the port group nodes 204a-204c represent the highest level (Level 2) of nodes with configuration parameters. The configuration resolver can thus move to the automatic configuration stage in which the process traverses the resource hierarchy 200 from top to bottom beginning at Level 2.

### 1. Auto-Configuration of Level 2 (Port Groups)

At port group node 204a for Port Group 1, the configuration process automatically configures the PLL setting parameter for Port Group 1. With reference to FIG. 7F, since the 50G option is the only option that honors the manual interface speed configuration of Et1/3, the configuration process selects the 50G option as the PLL setting configuration for Port Group 1.

At the port group node 204b for Port Group 2, the configuration process automatically configures the PLL setting parameter for Port Group 2. With reference to configuration space 732 in FIG. 7G, since the 50G option is the only option that honors the manual interface speed configuration of Et3/1, the configuration process selects the 50G option as the configuration for the PLL setting parameter of Port Group 2.

At the port group node 204c for Port Group 3, the configuration process automatically configures the PLL setting parameter for Port Group 3. With reference to configuration space 734 of FIG. 7G, both the 50G option and the 25G option are acceptable. The configuration process (per the selected configuration policy) may select between available options based on any number of factors. In one embodiment for example, the configuration process prioritizes configurations that maximize the data rate of a highest priority port affected by the configuration parameter. Accordingly, for the purposes of this example, suppose the configuration process (per the selected configuration policy) selects the 50G configuration as the PLL setting parameter for Port Group 3 because it provides the highest data rate for Et4/1.

### 2. Auto-Configuration of Level 3 (Ports)

Having completed the port groups in Level 2, processing can move down to the ports in Level 3.

At port node 206a (Port 1), the configuration process automatically configures the breakout mode parameter for Port 1. In particular, the configuration process selects a configuration that both adheres to the PLL setting of 50G configured for Port Group 1 and honors the manual configuration of Et1/3. As illustrated in the constrained configuration space 704 of FIG. 7C, either the 3-way mode or 4-way mode meets these constraints. The configuration process may select between the available options based on any number of factors. According to one embodiment, for example, the configuration process will prioritize the data rate of the highest priority interface (e.g., Et1/1) on the port. In this case, the 3-way mode maximizes the data rate of Et1/1. Accordingly, for the purposes of this example, suppose the configuration process (per the selected configuration policy) selects the 3-way breakout mode configuration for Port 1.

At port node 206b (Port 2), the configuration process automatically configures the breakout mode parameter for Port 2 in a manner that adheres to the PLL setting configuration of 50G selected for Port Group 1. Using the example of configuration space 706 (FIG. 7C), for the purposes of this example, we can assume without loss of generality the configuration process selects the 1-way mode as the breakout mode configuration for Port 2 because it maximizes the data rate of Et2/1.

At port node 206c (Port 3), the configuration process automatically configures breakout mode configuration parameter for Port 3 in a manner that adheres to the PLL setting of 50G configured for Port Group 2 and honors 100G-2 interface speed manually configured interface for Et3/1. Using the example of configuration space 712 (FIG. 7D), there are two breakout mode configurations that meet these constraints. The configuration process (per the selected configuration policy) may select between the available options based on any number of factors. Here, both options achieve the same data rate on Et3/1 and thus, another factor may be used. For example, in one embodiment, the configuration process may try to maximize the data rate on the next highest priority port interface and so on. For a 50G PLL setting, the 2-way breakout mode achieves the highest data rate on Et3/3. Accordingly, for the purposes of this example, suppose the configuration process selects the 2-way breakout as the breakout mode configuration for Port 3.

At port node 206d (Port 4), the configuration process selects a configuration for the breakout mode that adheres to the PLL setting of 50G configured for Port Group 3. Using the example of configuration space 714 (FIG. 7D), there are four breakout mode configurations that meet these constraints; 1-way, 2-way, 3-way, and 4-way. The configuration process may select between the available options based on any number of factors. Accordingly, for the purposes of this example, suppose the configuration process selects the 1-way breakout mode as the breakout mode configuration for Port 4 because it maximizes the data rate of interface Et4/1.

### 3. Auto-Configuration of Level 4 (Port Interfaces)

Having completed automatically configuring the ports at Level 3, processing can move to the next level, Level 4 to auto-configure the port interfaces.

At the port interface node 210a for Et1/1, the configuration process automatically configures the interface speed configuration parameter. The interface speed configuration is constrained by the 50G PLL configuration of Port Group 1 and the 3-way breakout mode configuration of Port 1 that were previously selected by the configuration process.

As can be seen in the constrained configuration space 724 in FIG. 7F, the 3-way breakout allocates lanes for port interfaces Et1/1, Et1/3, and Et1/4; interface Et1/2 is disabled. Accordingly, 100G-2 is the interface speed configuration that meets these constraints for Et1/1 and thus the configuration process can automatically configure the interface speed configuration parameter of Et1/1 to 100G-2. As noted, port interface Et1/2 is disabled because it is not allocated any lanes by the 3-way breakout mode configuration of Port 1. Et1/3 has a manually configured interface speed configuration parameter. For port interface Et1/4, the configuration process automatically configures the interface speed configuration parameter to 50G-1.

The process of configuring the interface speed parameters for the port interfaces can continue in similar fashion until all the port interface nodes 210a-210p have been automatically configured.

Table 3 below provides an example L1 configuration (excluding FEC and logical ports) of a network device configured in accordance with the present disclosure using resource hierarchy 200:

TABLE 3

| | Configuration | |
|---|---|---|
| Node/Resource | parameter | Configuration |
| Port Group 1 | PLL Setting | 50 G |
| Port 1 | Breakout Mode | 3-way |
| Et1/1 | Interface Speed | 100 G-2 |
| Et1/2 | Interface Speed | inactive |
| Et1/3 | Interface Speed | 50 G-1 (manually configured) |
| Et1/4 | Interface Speed | 50 G-1 |
| Port 2 | Breakout Mode | 1-way |
| Et2/1 | Interface Speed | 200 G-4 |
| Et2/2 | Interface Speed | inactive |
| Et2/3 | Interface Speed | inactive |
| Et2/4 | Interface Speed | inactive |
| Port Group 2 | PLL Setting | 50 G |
| Port 3 | Breakout Mode | 2-way |
| Et3/1 | Interface Speed | 100 G-2 (manually configured) |
| Et3/2 | Interface Speed | inactive |
| Et3/3 | Interface Speed | 100 G-2 |
| Et3/4 | Interface Speed | inactive |
| Port Group 3 | PLL Setting | 50 G |
| Port 4 | Breakout Mode | 1-way |
| Et4/1 | Interface Speed | 200 G-4 |
| Et4/2 | Interface Speed | inactive |
| Et4/3 | Interface Speed | inactive |
| Et4/4 | Interface Speed | inactive |

In this example, the first pass of traversing resource hierarchy 200 results in discovering the configuration space 742 (FIG. 7H) that comprises configurations for a plurality of configuration parameters, wherein the configuration space 742 is constrained by the manual configuration of a subset of the configuration parameters (e.g., configuration space 742 is constrained by the manual configurations of the Interface Speed configuration parameters of Et1/3 and Et 3/1).

In the second pass (auto-configuration), the remaining configuration parameters (that is, the ones that were not manually configured) are automatically configured to generate an L1 configuration that includes the manually configured configuration parameters (e.g., the manually configured Interface Speeds for Et 1/3 and Et 3/1) and the automatically configured configuration parameters, where the L1 configuration of Table 3 falls within the solution space represented by constrained configuration space 742.

Logical ports and FEC configuration parameters can be configured when the node holding the logical port parameter or FEC parameter is processed as part of traversal of the resource hierarchy during the automatic adjustment stage. For example, the logical ports may be set to satisfy the maximum number of port interfaces possible under the possible breakout modes for the port. The FEC mode may also be set automatically. According to one embodiment, if the IEEE mandates a FEC mode for an interface speed (e.g., RS544 on PAM4 modes) the IEEE mandated FEC mode is selected. Otherwise, if the inserted media has a FEC standard for the interface then the media FEC standard is selected.

The above description illustrates various embodiments in accordance with the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents may be employed without departing from the scope of the disclosure as defined by the claims.

1. A method for configuring Layer 1 resources in a network device, the method comprising:
receiving a topology of the Layer 1 resources (“resources”) in the network device;
generating a resource hierarchy based on interconnections between resources represented by the Layer 1 topology, wherein each node in the resource hierarchy corresponds to an instance of a resource in the network device;
initializing nodes in the resource hierarchy that correspond to resources for which there are user-specified settings by initializing configuration parameters of the corresponding resources to values based on the user-specified settings (manually configured parameters);
constraining nodes in the resource hierarchy based on the manually configured parameters in the initialized nodes;
configuring remaining configuration parameters by traversing the resource hierarchy to visit nodes in the resource hierarchy and for each visited node:
determining values for configuration parameters of a resource corresponding to the visited node, wherein valid values for the configuration parameters are limited by any constraints imposed on the visited node; and
constraining nodes that descend from the visited node based on the configuration parameters of the visited node; and
configuring the Layer 1 resources of the network device using the configuration parameters in the resource hierarchy.

2. The method of claim 1, wherein constraining nodes (constrained nodes) in the resource hierarchy based on the manually configured parameters in the initialized nodes includes limiting possible values that can be assigned to the configuration parameters of resources corresponding to the constrained nodes.

3. The method of claim 1, wherein the nodes constrained by the manually configured parameters in the initialized nodes are ancestors of the initialized nodes.

4. The method of claim 1, wherein constraining nodes (descendant nodes) that descend from the visited node includes limiting possible values that can be assigned to the configuration parameters of resources corresponding to the descendant nodes based on the determined values of the configuration parameters of the visited node.

5. The method of claim 1, wherein determining values for configuration parameters of the resource corresponding to the visited node excludes determining values for any manually configured parameters of the resource.

6. The method of claim 1, wherein traversing the resource hierarchy starts from a highest level in the resource hierarchy and proceeds to lower levels one level at a time, wherein every node at one level is visited before proceeding to the next lower level.

7. The method of claim 1, further comprising:
generating configuration data from the configuration parameters established in the resource hierarchy; and
using the generated configuration data to configure the Layer 1 resources of the network device.

8. A network device comprising:
one or more computer processors; and
a computer-readable storage device comprising instructions that control the one or more computer processors to:
access a resource hierarchy that represents the network device, wherein the resource hierarchy comprises a hierarchical structure comprising nodes representing independently configurable instances of Layer 1 (L1) hardware resources of the network device and holding first configuration parameters with associated configuration spaces of allowable configurations corresponding to the independently configurable instances of the L1 hardware resources;
receive a manual configuration for second configuration parameters;
traverse the resource hierarchy to automatically configure third configuration parameters, the third configuration parameters being a subset of the first configuration parameters;
output an L1 configuration for the network device, the L1 configuration including the manually configured second configuration parameters and the automatically configured third configuration parameters; and
configure the network device according to the L1 configuration.

9. The network device of claim 8, wherein traversal of the resource hierarchy includes constraining the configuration spaces of one or more of the third configuration parameters based on the manually configured second configuration parameters.

10. The network device of claim 9, wherein constraining the configuration spaces of one or more of the third configuration parameters comprises performing a bottom-up traversal of the resource hierarchy.

11. The network device of claim 8, wherein traversal of the resource hierarchy further comprises performing a top-down traversal to automatically configure the third configuration parameters.

12. The network device of claim 8, wherein configuration of a configuration parameter is binding on the configuration space of any descendent interdependent configuration parameter.

13. The network device of claim 8, wherein an automatically configured configuration parameter is bound by all descendant configuration parameters that are manually configured.

14. The network device of claim 8, wherein the resource hierarchy reflects a topology of the instances of the L1 hardware resources of the network device.

15. A method in a network device for configuring Layer 1 resources in the network device, the method comprising:
accessing a resource hierarchy that represents the network device, wherein the resource hierarchy comprises a hierarchical structure comprising nodes representing independently configurable instances of Layer 1 (L1) hardware resources of the network device and holding first configuration parameters with associated configuration spaces of allowable configurations corresponding to the independently configurable instances of the L1 hardware resources;
receiving a manual configuration for second configuration parameters, the second configuration parameters being a first subset of the first configuration parameters;
traversing the resource hierarchy to automatically configure third configuration parameters, the third configuration parameters being a second subset of the first configuration parameters;
outputting an L1 configuration for the network device, the L1 configuration including the manually configured second configuration parameters and the automatically configured third configuration parameters; and
configuring the network device according to the L1 configuration.

16. The method of claim 15, wherein traversing the resource hierarchy includes constraining the configuration spaces of one or more of the third configuration parameters based on the manually configured second configuration parameters.

17. The method of claim 15, wherein traversing the resource hierarchy further comprises performing a bottom-up traversal to determine the constrained configuration space.

18. The method of claim 15, wherein traversing the resource hierarchy further comprises performing a top-down traversal to automatically configure the third configuration parameters.

19. The method of claim 15, wherein configuration of a configuration parameter is binding on the configuration space of any descendent interdependent configuration parameter.

20. The method of claim 15, wherein an automatically configured configuration parameter is bound by all descendant configuration parameters that are manually configured.
